(19) United States
(12) Patent Application Publication
(10) Pub. No.: US 2001/0051240 A1
(43) Pub. Date: Dec. 13, 2001

(54) Means and a method for protecting deglet noor dates

(76) Inventor: Stephen Paul Denis, Indio, CA (US)

Correspondence Address: STEPHEN P. DENIS, P. O. BOX 6, THERMAL, CA, 92274, US

(21) Appl. No.: 09/928,325

(22) Filed: Aug. 13, 2001

Related U.S. Application Data
(63) Continuation-in-part of application No. 29/034,825, filed on Feb. 13, 1995, now abandoned.
(63) Continuation-in-part of application No. 09/615,490, filed on Feb. 22, 1999, now abandoned.

(51) Int. Cl. B32B 1/02

(52) U.S. Cl. 428/36.1

(57) ABSTRACT

Deglet Noor is the major date variety grown and packed in the United States. The crop is increasingly attacked by insects while ripening on the palm, especially carob moth. These pests are presently a serious threat to the livelihood of both conventional and organic date growers. Infestation rates already average 10% to 20%. Malathion, the only insecticide registered for use on dates, is ineffective because the insects have developed resistance. Such broad-spectrum, organophosphate pesticides are under heavy regulatory pressure because of the hazards they pose to workers, the community and the environment. The present invention provides a physical barrier in the form of cloth bag to exclude insects. This date-bunch cover also protects the on-tree crop from birds, heavy rain, high winds, and sunburn. The cover is composed of a flexible fabric, preferably white, woven, open-mesh polyester, which allows free circulation of air throughout the fruit cluster. Layering the fabric on top of the bunch provides rain protection. Accordingly, many advantages over prior art are realized in terms of effect upon the fruit and economy of use. The manner and time of installation are crucial, and thus described in detail. The cover is durable, light-weight and reusable. Additionally, the seams are overedged with color-coded thread for the purpose of identification.

### CROSS-REFERENCES TO RELATED APPLICATIONS

This application is a continuation-in-part of Ser. No. 29/034,825, filed Feb. 13, 1995 and Ser. No. 09/615,490, filed Feb. 22, 1999, both now abandoned.

### STATEMENT REGARDING FEDERALLY SPONSERED RESEARCH AND DEVELOPMENT

Not Applicable

### REFERENCE TO A “MICROFICHE APPENDIX”

Not Applicable

### BACKGROUND OF THE INVENTION

1. Technical Field

This invention relates to a means and method for protecting Deglet Noor dates from birds, rain, insects, wind, and sunburn while on the palm, and in particular to a cover for such purpose which is economical to use.

2. Background Art

The major variety of date cultivated in the United States is Deglet Noor, “the Date of Light”, known for its beautiful, translucent, amber color and incomparable, delicious flavor. Furthermore, this luxury date is also the processing date par excellence. In the early 1900's, Deglet Noor offshoots were brought from Algeria and Tunisia to the Coachella Valley in the arid southeast corner of California, where the desert closely resembles its homeland. The mature palms produce heavily; however, carob moth, a species native to the Mediterranean region, which was first discovered here in 1982, infests the crop more every year. This vociferous pest is now well-established amid a range of hosts and, in classic fashion, has become resistant to malathion, the only insecticide registered for use on dates. Malathion is an organophosphate pesticide which is relied upon also to control raisin moth and dried-fruit beetles. The introduction of a new insecticide, another “silver bullet”, for controlling date pests is highly unlikely given the registration costs, regulatory pressures and environmental implications. Moreover, the hazard to workers and the harmful effects of drift cause great concern in the community. The advantages of a physical barrier over a broad-spectrum pesticide are numerous.

The design requirements for the ideal date-bunch cover were known to researchers as early as 1935, and elaborated upon in 1949 by D. E. Bliss et al in the classic work, Date-Bunch Covers and Their Relation to the Fruit-Spoilage Complex of Deglet Noor Dates: “ . . . waterproof during heavy rains, allowing circulation of air throughout the fruit cluster, excluding insects and birds, and costing only a nominal amount . . . one that [also] protects the fruit stalk and strands from sunburning”. The researchers concluded that the cover must allow maximum aeration because some of the water vapor constantly transpired by the fruit surfaces is trapped by the cover and leads to water injury and fungus infection. The latter requirement, however, was tempered when it was found that excessive aeration in dry years increased the shriveling of the fruit.

The first recorded date-bunch cover (1919) in the United States was baglike, made of paper and provided with holes for ventilation. However, if ventilation was adequate, rain protection was poor. And, of course, insects entered the holes. Eventually, a “flap fold”, which created a large opening to ventilate the fruit but kept rain out, was substituted for the “breather holes”.

The best paper available for covers is naturally brown, 55-pound, Kraft, wet-strength paper, which provides excellent rain protection but, unfortunately, absorbs enough heat from the sun to burn the fruitstrands and create a hot house effect that increases fungus spoilage. White paper keeps the bunch cool, but is weakened by the bleaching process. Waterproofing the paper with wax eventually proved very detrimental. Regardless of the color or treatment, unvented paper covers retard the ripening of the fruit because they reduce the rate of transpiration. Even an umbrella-like cover traps too much moisture.

The paper cover in use today is a sheet which measures about 48 inches by 48 inches, with one corner cut, and is wrapped tightly in the shape of a cone around as much of the bunch as possible; left open at the bottom; stapled along one side; and then tied securely to the fruitstalk. This cover has several drawbacks: Air is trapped inside most, if not all, the fruiting portion of the bunch; the fruit cluster is compressed; insects enter freely; it blows apart during high winds; and, furthermore, in contradistinction to early tube-shaped covers, it is not reusable.

Various forms of cloth covers—untreated, dipped in insecticides, or waterproofed—have been tried commercially: burlap sacks; muslin wraps and tubes; cotton, cotton/polyester and, most recently, 100% polyester. All other types of synthetic cloth, plastic paper or film, which offer any usefulness, would either ruin the fruit or are not worth the expense. The cloth cover used extensively since the 1980s is tube-shaped, about 48 inches long and 58 inches in circumference and made of light-weight, white, woven, open-mesh polyester fabric which resembles mosquito netting. It is slipped around the bottom of the bunch, raised up, puckered at the top and tied to the fruitstalk. The bottom of the cover is also tied shut to catch dropped fruit and exclude insects. Designed for protecting Medjool bunches, this cover is neither long nor wide enough for the Deglet Noor variety.

Combining the paper and cloth covers commonly used today without significant modification restricts aeration and compresses the fruit cluster more than when either are installed separately.

U.S. Pat. No. 2,555,561, “Chemically Treated Laundry Bag”, discloses a woven, open-mesh cloth bag used in commercial laundering operations, which is made of high-tenacity regenerated cellulose yarn. Unlike mesh fabrics designed for excluding insects, laundry bags must allow the free circulation of liquids and, therefore, require a relatively large mesh as shown in the drawing.

Conversely, U.S. Pat. No. 5,535,543, “Means and a Method for Thermally Protecting Fruits and Vegetables While Maturing”, is directed to a bag that only allows water to seep through. Nowhere in the patent is the material described as mesh. The globular shape and elasticized opening are of no value for protecting dates. The main function of the invention is the opposite of what is required of a date-bunch cover. Insulation is measured by “R” factor, a unit of resistance of motionless air. Thermally insulating fruit involves protecting it from contact with outside cold air and wind which cause its internal heat and moisture to dissipate. A bunch of 900 full-grown dates at temperatures between 70° and 122° F. must lose several cups of water everyday in the form of water vapor from the stomata of the fruit during ripening. Thermally insulating a date bunch, when free circulation of air is vital, would certainly ruin the fruit.

U.S. Pat. No. 4,646,467, “Weather Resistant Cover Bag for Dormant Plants”, also teaches a means and method of protecting plants against cold injury. Although the cover would have to be turned upside down, the shape and size of the bag disclosed is, in fact, perfectly suitable for covering a date-bunch; however, the two layers forming the wall of the bag are designed to limit air and vapor flow enough to create a “dead air pocket” between them. Inside the “closed dark chamber” provided by the cover to prevent premature growth, dates would ripen improperly and eventually rot.

Researchers in 1948 experimented with a combination paper-and-cloth cover, composed of a short, white, Kraft paper hood waterproofed with wax, and sewn to a skirt of netting. Despite good aeration and virtually complete protection against insects, this design failed because cotton netting, apparently the only type economical at the time, absorbed moisture with disastrous results.

U.S. patent application Ser. Nos. 29/034,825 and 09/615,490 disclose a two-piece cover, which retains the approximate size of the hood experimented with earlier and substitutes polyester for cotton. In this design, the inner part comprises a sheet of naturally brown, 55-pound, Kraft, wet-strength paper wrapped mainly around the upper portion of the fruit strands. The outer part is a cloth bag, which measures about 58 inches long by 36 inches wide and comprises a fabric slightly heavier than what is commonly used. Cloth shades the paper, and protects it from high winds. The bottom of the cover is sewn, rather than tied shut, which avoids compressing the fruit cluster and allows dropped fruit to roll into two comers. The only drawback of this cover is the relatively high cost of manufacture and installation.

### BRIEF SUMMARY OF THE INVENTION

The invention will be hereinafter described as embodied in a cover for Deglet Noor dates, but it is to be understood that the cover of this invention provides protection for any variety of dates, especially those which are picked only once each season and suitable for on-tree storage.

The primary object of the present invention resides in the provision of a cloth bag which fulfills all of the above requirements for the ideal date-bunch cover, and which is economical to use.

A further object of the invention is to provide a simple way to positively identify the owner of the cover in case of theft.

Accordingly, the means and method for protecting Deglet Noor dates while on the palm involve slipping a cloth bag over the bunch, and wrapping or folding the upper portion of the bag in such a manner as to obviate the need for paper. The bag is large enough so as not to compress the bunch. The cloth is an open-mesh fabric which allows free circulation of air, yet excludes insects and birds, and partially shades the bunch. The fabric comprises a material which is water-repellant and resists deterioration in prolonged sunlight, such that the bag is reusable for many years. The seams are overedged with color-coded thread for the purpose of identification.

Other objects, features and advantages of the present invention will become apparent from the following description and accompanying drawings.

### BRIEF DESCRIPTION OF THE SEVERAL VIEWS OF THE DRAWINGS

FIG. 1 is a front perspective view of the bag installed on a large date bunch, shown with the upper portion of the bag wrapped around the top of the bunch;

FIG. 2 is a left side perspective view thereof; and

FIG. 3 is a front perspective view thereof installed on a small date bunch, shown with the bag raised and the top folded down.

### BEST MODE FOR CARRYING OUT THE INVENTION

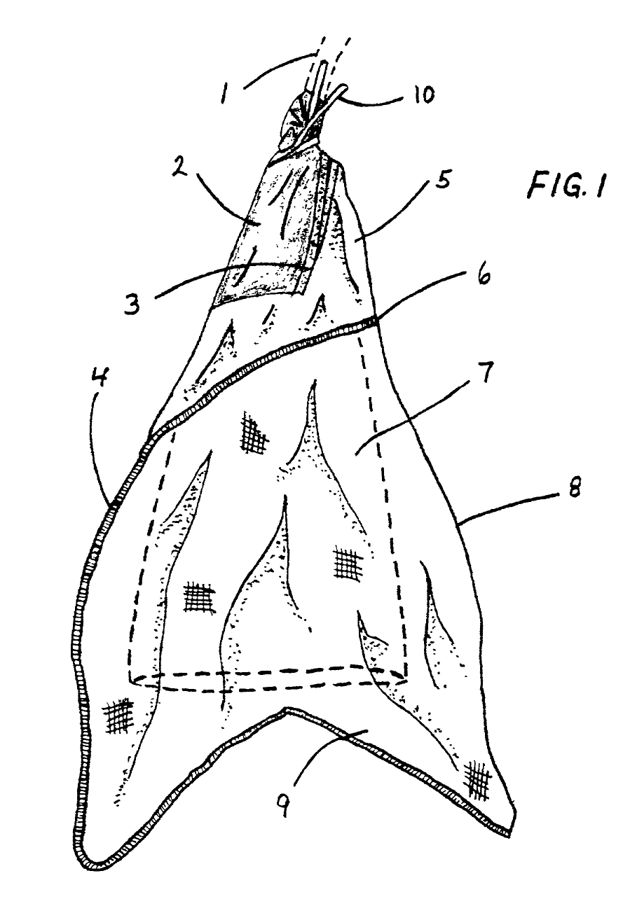

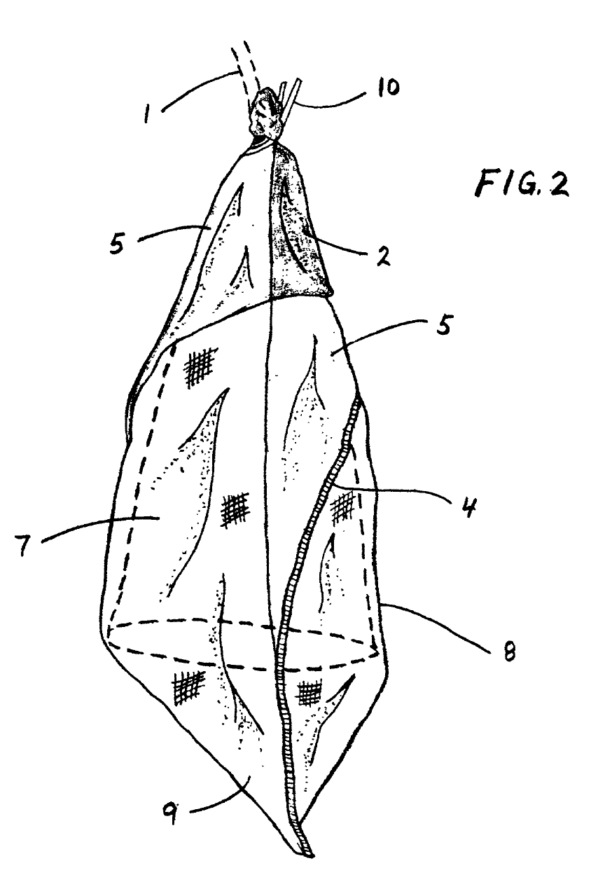

The present invention comprises the use of a bag-shaped cover for protecting Deglet Noor dates from birds, rain, insects, wind, and sunburn, while on the palm, which is made of a flexible fabric that allows free circulation of air throughout the fruit cluster, yet excludes insects and birds, provides a windbreak, and partially shades the bunch. To fully realize the advantages of the invention the preferred embodiment includes the installation of the bag in the proper manner and at the right time, as will be described in detail below. Turning now to the Figures, the bag 8 of FIGS. 1 and 2 is shown installed on a large date bunch 7 while on the palm. The bag is made of white, woven, open-mesh polyester fabric weighing about 2.5 to 3.3 ounces per square yard and having a cloth count of approximately 32 warps by 26 fills per square inch. The L-seam 4 is overedged with color-coded thread, so as to positively identify the owner. Selvage 3 is at the top. The bag is preferably at least 58 inches long and 36 inches wide, in order to be of ample size. The large date bunch represented by broken lines is about 36 inches long and 22 inches diameter at the bottom. The upper portion 5 of the bag 8 is wrapped around the upper portion of the bunch, thereby forming a hood. A twist tie 10 anchors the top of the bag in a tightly closed condition around the bottom of the fruitstalk 1, so as to completely enclose the bunch. The bag sheds rain completely wherever the fabric overlaps 2 and 5. The upper portion of the bunch covered in this fashion is also the area needing shade the most.

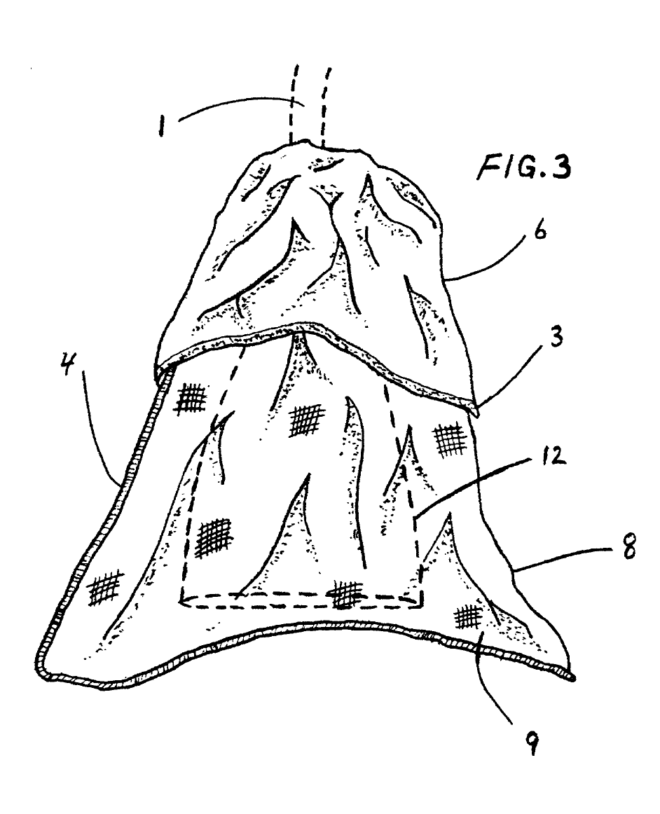

The bag 8 of FIG. 3 is shown installed on a small date bunch 12 while on the palm. The bag is composed of the same fabric as the bag of FIGS. 1 and 2. The bottom 9 of the bag is raised to within a few inches of the bottom of the bunch. The middle portion is puckered around the bottom of the fruitstalk. A twist tie, which is hidden from view, anchors approximately the middle of the bag in a tightly closed condition around the bottom of the fruitstalk 1, so as to completely enclose the bunch. The portion of the bag protruding above the twist tie is folded down and over the top of the bunch 6, thereby forming an umbrella-like structure, such that the upper portion of the bunch is shaded and the fruit cluster is protected from rain.

There are many advantages to sewing the bottom of the cover, rather than tying it shut: 1) the same amount of fabric accommodates a longer bunch; 2) dropped fruit, which is usually rotten or infested, rolls to the bottom corners of the bag and rests farther away from sound fruit; 3) the installer does not have the difficult task of tying the bottom of the cover shut while suspended along the side of the bunch; 4) the tent shape keeps the surface of the cover and, thereby, also rain away from the fruit; 5) the very bottom of the fruit cluster, especially, is not compressed; and, 6) when stowing the bags after harvest, twist ties do not have to be removed. Fortunately, Deglet Noor dates are picked once each season and, therefore, it is not necessary to open the cover before harvest, except to occasionally monitor the status of the crop.

The bag is necessarily much larger than the tube used on the Medjool variety; however, the ones used formerly on the Deglet Noor variety were the same size as the present invention. The reason the latter were not sewn at the bottom or made longer is probably because shortening the fruitstrands considerably before bagging was standard practice in those days. Since then, growers have found that the fruitstrands can be left longer without compromising quality.

When a Deglet Noor bunch is especially large the paper wrap is unable to cover it completely. This allows birds to peck at the exposed dates. The bag is of ample size to enclose the entire bunch.

The concentric overlapping layers (hood) and folded down portion (umbrella) incorporated in the preferred embodiment provide rain protection equal to wet-strength paper. Moreover, the bag cannot be blown apart, as is often the case with the paper cover. What little rain reaches the dates quickly dissipates in dry weather because of the air flow. Under humid conditions, the bag is of advantage because moisture is not trapped.

The greatest advantage offered by the present invention is protection against insects. Chemical control even at its best, does not outweigh the costs to workers, the community and the environment. Presently, the pesticide of choice is ineffective, and no substitute is registered for use on dates, or might ever be. Infestation rates of 2% or less are easily achievable when bagging the bunches compared with typically 10% to 20%, and as high as 60%, using malathion and paper covers.

When malathion was effective, the use of paper covers was not widely questioned. Now, however, yield is beginning to be drastically reduced. Carob moth has become as great a threat to conventional date growers as those farming organically.

The microenvironment inside the bag is conducive to the production of high quality fruit, while there is nothing overwhelmingly positive known in terms of effect upon the fruit about wrapping paper around dates, unless the goal is to allow the introduction of a pesticide. The practice is actually a recipe for lowering quality. Ironically, cloth covers work even better than paper covers in conjunction with dusts because once inside, the dust is not blown off.

The desiccation of fruitstrands is an unavoidable problem with the paper cover. Heat from direct sunlight is absorbed and transfers through to the bare upper portion of the strands the paper rests upon. The flow of fluids is cut off and shriveling of fruit occurs along the strand.

Other quality-related advantages to the use of present invention are earliness and evenness of ripening. This results from the fact that paper retards the rate of transpiration and, therefore, the driving force of ripening, to the degree that the dates are covered. Since the bunch is never affected equally under the paper cover, and often not at all on the bottom, uneven ripening occurs. The bag allows free circulation of air throughout the fruit cluster. Increased uniformity is a boon to packers because the dates are then easier to grade and more attractive to customers.

On-tree storage of Deglet Noor dates is made possible with the present invention. Until now, protection against birds, insects and high winds was inadequate. On-tree storage is mainly of logistic value; nevertheless—when conditions are right—the longer dates remain on the bunch, the better the quality.

The manner of using the cover of the present invention is similar to that of the tube-shaped cover for the Medjool variety. Besides slipping the cover over the bunch, effort is given to forming either a “hood” or “umbrella” at top during installation, rather than tying shut the bottom. The means of fastening the cover to the fruitstalk are the same.

A hood should be formed on large bunches, because they have a length such that not enough of the bag can be folded down over the top to provide an effective rain barrier. Forming the hood is accomplished by centering the top of the bag around and a few inches above the top of the bunch with a corner in each hand, and then folding both sides in the same direction with a spiraling motion that forms concentric overlapping layers around the upper portion of the bunch. This necessitates switching hands as the corners spiral around the fruitstalk. Wrapping the fabric around the upper portion of the bunch requires skill like installing the paper cover and, therefore, takes practice.

An umbrella-like structure should be formed on small to medium size bunches because it is easier to make but just as effective against rain. The bag should be centered around the bunch and positioned such that the bottom is a few inches below the bottom of the bunch. The middle of the bag is then puckered where it meets the bottom of the fruitstalk and securely tied. Finally, the top portion of the bag, which protrudes above the twist tie, is folded down and over the top of the bunch. This installation is a simple operation that requires little skill.

Unlike the paper cover, the bag of the present invention is reusable. Polyester, the preferred fiber for the fabric, is strong, water-repellant, resistant to ultraviolet rays, and relatively inexpensive. The serviceable life of the bag with proper care is at least seven years, and perhaps more than ten. Maintenance of the bag is the same as the cover for the Medjool variety.

The time of installation is governed by several rules: never before sulfur dusting; after the peak of “June Drop”; taller palms first; and, finish before the tip of the dates start to soften. Regardless of when the bag is installed, the bunch should always be vigorously shaken, the fruitstrands spread and the center opened to get rid of trash fruit which is usually infested. Bagging does not interfere with mite control, nor require changes in any other pre-harvest cultural practices.

During harvest, it is of utmost importance that dropped dates caught inside the bag be kept entirely separate from the sound dates on the bunch. Separate containers for this purpose should be available at all times when picking. At least half of these dates will be culls, and such lots will rarely be worth grading.

The standard for comparing the relative merits of date-bunch covers is stated by D. E. Bliss et al in The Second Report on Date-Bunch Covers and Their Relation to the Fruit-Spoilage Complex of Deglet Noor Dates (1950): a) the effect on the fruit, and b) economy of use. This standard should be expanded to include natural resource accounting for the destruction of beneficial insects, and the additional money spent on pesticides by growers in lieu of biological control. In these terms, the advantage of a physical barrier over a broad-spectrum insecticide are enormous. The advantage of the present invention over the use of the paper cover in terms of effect upon the fruit is incontrovertible. Economy of use will follow from increased yield, ease of installation and long serviceable life.

Accordingly, the present invention provides a means and method for protecting Deglet Noor dates from birds, rain, insects, wind, and sunburn while on the palm, and in particular a cover for such purpose which is economical to use.

It will be readily apparent to the those skilled in the art that various changes and modifications of an obvious nature may be made without departing from the scope of the novel concepts of the present invention. For example, the cover can have a different shape or be a different color; the cover can be bigger or smaller; a different fiber can be substituted for polyester; or, the cover can be simply puckered around the bottom of the fruitstalk and anchored thereto with a twist tie in the same manner as the cover for the Medjool variety is installed.

Thus the scope of the invention should be determined by the appended claims and their legal equivalents, rather than by the examples given.

I claim:

1. A cover for protecting Deglet Noor dates from birds, rain, insects, wind, and sunburn while on the palm, which comprises:
(a) said cover being in the shape of a bag;
(b) said bag being of ample size to enclose a large bunch;
(c) said bag being composed of a flexible fabric which allows free circulation of air throughout the fruit cluster, yet excludes insects and birds, provides a windbreak, and partially shades said bunch;
(d) said fabric made of water-repellant, UV resistant fiber; and
(e) means for anchoring the top of said bag to the fruitstalk of said bunch.

2. The cover of claim 1 wherein said fabric is white, woven, open-mesh polyester having a weight of about 2.5 to 3.3 ounces per square yard.

3. The cover of claim 1 wherein said fabric has a cloth count of approximately 32 warps by 26 fills per square inch.

4. The cover of claim 1 wherein the L-seam of said bag is overedged with color-coded thread, so as to positively identify the owner of said cover.

5. A method for protecting Deglet Noor dates from birds, rain, insects, wind, and sunburn, while on the palm, which comprises the steps of:
(a) providing a cover for said dates, said cover being in the shape of a bag, said bag being of ample size to enclose a bunch and composed of a flexible fabric which allows free circulation of air throughout the fruit cluster, yet excludes insects and birds, provides a windbreak, and partially shades said bunch, said fabric being made of water-repellant, UV resistant fiber;
(b) slipping said bag over the bunch;
(c) wrapping the upper portion of said bag in a spiraling fashion to form concentric overlapping layers around the upper portion of said bunch, whereby a hood is formed, such that the upper portion of said bunch is shaded, and said fruit cluster is protected from rain; and
(d) providing means for anchoring the top of said bag in a tightly closed condition around the bottom of the fruitstalk, so as to completely enclose said bunch.

6. A method for protecting Deglet Noor dates from birds, rain, insects, wind, and sunburn, while on the palm, which comprises the steps of:
(a) providing a cover for said dates, said cover being in the shape of a bag, said bag being of ample size to enclose a bunch and composed of a flexible fabric which allows free circulation of air throughout the fruit cluster, yet excludes insects and birds, provides a windbreak, and partially shades said bunch, said fabric being made of water-repellant, UV resistant fiber;
(b) slipping said bag over the bunch;
(c) positioning said bag such that the bottom of said bag is a few inches below the bottom of said bunch;
(d) puckering the middle portion of said bag around the bottom of the fruitstalk;
(e) providing means for anchoring approximately the middle of said bag in a tightly closed condition around the bottom of said fruitstalk, so as to completely enclose said bunch; and
(f) folding down and over the top of said bunch the portion of said bag protruding above where said bag is anchored to said fruitstalk, so as to form an umbrella-like structure, such that the upper portion of said bunch is shaded, and said fruit cluster is protected from rain.
